(19) United States
(12) Patent Application Publication
(10) Pub. No.: US 2024/0290085 A1
(43) Pub. Date: Aug. 29, 2024

(54) CLASSIFICATION OF INTERFERENCE WITH DIAGNOSTIC TESTING OF DEFECTS IN BLANK TEST CARDS

(71) Applicant: BIO-RAD EUROPE GMBH, Basel (CH)

(72) Inventor: Thomas Picard, Chazay d'Azergues (FR)

(21) Appl. No.: 18/572,506

(22) PCT Filed: Jun. 24, 2022
(86) PCT No.: PCT/IB2022/000369

§ 371 Date: Dec. 20, 2023

Related U.S. Application Data
(60) Provisional application No. 63/215,318, filed on Jun. 25, 2021.

(51) Int. Cl. G06V 10/98; G01N 21/88; G06V 10/75; G06V 10/764; G06V 10/776; G06V 20/69

(52) U.S. Cl. CPC G06V 10/993; G01N 21/8851; G06V 10/75; G06V 10/764; G06V 10/776; G01N 2021/8887; G06V 20/698; G06V 2201/03

(57) ABSTRACT

An input image is received from testing equipment. One or more synthetic images are generated by applying an image-to-image translation model to the input image. Based on the one or more synthetic images. a binary classifier is applied to determine a classification for the received input image.

### CROSS-REFERENCE TO RELATED APPLICATIONS

This application claims the benefit of U.S. Provisional Application No. 63/215,318, filed Jun. 25, 2021, which is hereby incorporated in its entirety by reference.

### BACKGROUND

### Technical Field

The subject matter described herein generally relates to diagnostic testing, and in particular to classifying blank test cards (such as gel cards) to predict whether characteristics of the blank test card will interfere with the diagnostic testing.

### Background Information

Many medical tests produce results in the form of test cards. Those test cards may be processed at test stations configured to interpret the outcome of a test. However, blank test cards may contain a number of defects that may impact the test station's ability to properly process the test card. However, it might be hard for a person to determine whether a defect will impact the test station's ability to process the test card until after the test card has been used and entered to the test station. This may result in time and samples being wasted by users employing defective test cards that eventually result in an incorrect reading, or in resources being wasted by users discarding test cards having defects that would not have interfered with the test station's ability to properly process the test card.

### SUMMARY

The above and other problems are addressed by computing devices and methods for testing blank test cards using images captured by the testing equipment. The computing device receives an input image from testing equipment and generates one or more synthetic images by applying an image-to-image translation model to the input image. Using a trained model, the computing device classifies the one or more synthetic images. Moreover, the computing device applies a binary classifier using the classification of the one or more synthetic images to determine a classification for the received input image.

### BRIEF DESCRIPTION OF THE DRAWINGS

FIG. 1 is a block diagram of a system suitable for reading a test card, according to one embodiment.

FIG. 2 is a block diagram illustrating an example of a computer for use in the system of FIG. 1, according to one embodiment.

FIG. 3A is a side view of a gel card, according to one embodiment.

FIG. 3B is an elevation view of a well of a gel card, according to one embodiment.

FIG. 4 is a block diagram of the testing equipment shown in FIG. 1, according to one embodiment.

FIG. 5 is a block diagram illustrating the diagnostic system shown in FIG. 1, according to one embodiment.

FIG. 6 is a flowchart of a method for using a test card using the camera of a testing equipment, according to one embodiment.

FIG. 7 illustrates multiple examples of an image-to-image translation of wells in a gel card, according to one embodiment.

FIG. 8 illustrates an example of a system using multiple image-to-image translation models, according to one embodiment.

FIG. 9 illustrates multiple examples of source images and synthetic images generated using an image-to-image translation model, according to one embodiment.

### DETAILED DESCRIPTION

Systems used in a wide variety of applications are susceptible from defects or imperfections that are introduced at various points throughout the system's lifecycle. For example, in a biological testing application that uses images of test cards to allow an electronic system to analyze the test card the various components of the system may contain a number of defects that could cause the electronic system to provide an incorrect reading of the outcome of the biological test. For example, the test card itself may contain defects that were introduced during manufacturing, distribution, or storage of the test card.

To improve the efficiency of the system, a user consuming a test card may want to test the quality of the test card prior to determine whether to proceed or whether to discard the test card as being defective. The user might visually inspect the test card, but the user might be unable to accurately determine whether certain defects will impact the electronic system's ability to process the test card. As such, the electronic system itself is equipped with a module for testing the blank test cards to inform the user whether to proceed with using the blank test card despite certain defects being present in the test card, or to discard the test card. As such, the testing of the quality of the blank test card prior to being consumed can prevent the use of defective test cards that would lead to an unsuccessful or incorrect reading of the test card, and can prevent the waste of defective test cards that are of sufficient quality to be used in conjunction with the electronic system. The term “blank test card” is used herein to mean a test card for which an intended biological or other chemical reaction that produces a test result for a sample has not occurred. Referring to a test card as blank does not necessarily (although may) mean that no preparation for the test (e.g., addition of a reagent or diluent in the test card) has been performed.

The Figures (FIGS.) and the following description describe certain embodiments by way of illustration only. One skilled in the art will readily recognize from the following description that alternative embodiments of the structures and methods illustrated herein may be employed without departing from the principles described. Reference will now be made to several embodiments, examples of which are illustrated in the accompanying figures. It is noted that wherever practicable similar or like reference numbers may be used in the figures and may indicate similar or like functionality.

### System Overview

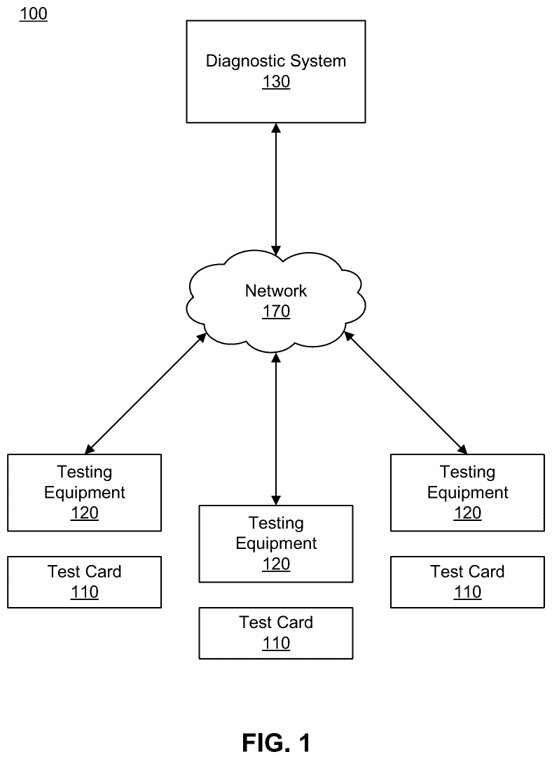

FIG. 1 illustrates one embodiment of a system 100 suitable for reading a test card 110. As shown, the system 100 includes one or more testing equipment 120 connected to a diagnostic system 130 via a network 170. Other embodiments of the system 100 include different or additional components. In addition, the functions may be distributed among the components in a different manner than described. For example, in various embodiments, some or all of the processing attributed to the diagnostic system 130 is performed locally on the testing equipment 120. In embodiments where all of the processing is performed locally, the diagnostics server 130 and network 170 may be omitted entirely.

A test card 110 is a visual record of the result of a diagnostic test. Moreover, in some embodiments, the test card 110 includes the mechanisms for conducting one or more diagnostic tests. FIG. 1 shows three tests cards 110 for illustrative purposes. However, in practice, any number of test cards may be present in the proximity of testing equipment 120 at any given time. Although the term “card” is used, this should not be taken to limit the structure of a test card 110. In various embodiments, test cards 110 include printed documents, cartridges, cassettes, test kits, gel cards, plates (e.g., microplates), tubes (e.g., microtubes), immunochromatographic cassettes, and the like. One of skill in the art will recognize numerous examples as well as other types of test card 110 that may be read by the system 100 without deviating from the principles or scope of this disclosure.

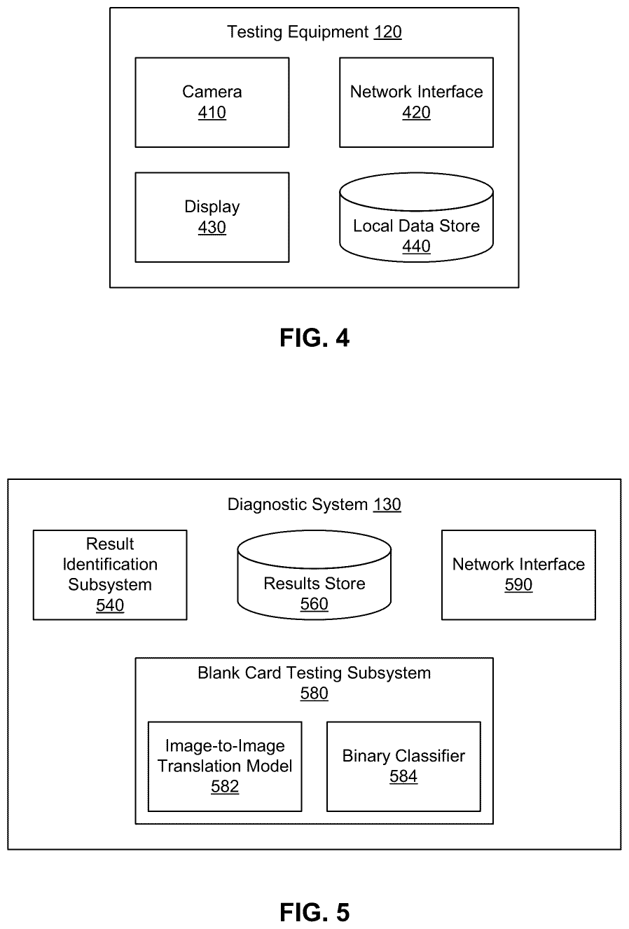

In various embodiments, the testing equipment 120 are devices carried or worn by users that include a camera, such as smartphones, tablets, personal digital assistants, smartwatches, smartglasses, safety glasses with an attached camera, head-mounted cameras, and the like. Dedicated test readers that are designed to provide the described function of the testing equipment 120 may also be used instead of or in addition to other types of testing equipment. Embodiments of the testing equipment 120 are described in greater detail below, with reference to FIG. 4.

In one embodiment, a user captures an image of a test card 110 using a testing equipment 120. The image can be black and white or color and may be captured without using any special mounting equipment or otherwise preparing the test card prior to image capture. The image is sent to the diagnostic system 130 (e.g., via network 170). The diagnostic system 130 analyzes the image to determine the test results indicated by the test card 110. The diagnostic system 130 sends the test results to the testing equipment 120 (e.g., via network 170), which displays them to the user. Thus, the user can use a testing equipment 120 to ascertain the test results indicated by a test card 110. Embodiments of the diagnostic system 130 are described in greater detail below, with reference to FIG. 5.

The network 170 enables the components of the system 100 to communicate with each other. In one embodiment, the network 170) uses standard communications technologies and/or protocols and can include the Internet. Thus, the network 170) can include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 170 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), etc. The data exchanged over the network 110 can be represented using technologies and/or formats including image data in binary form (e.g. Portable Network Graphics (PNG)), hypertext markup language (HTML), extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the entities on the network 170 can use custom and/or dedicated data communications technologies instead of, or in addition to, the ones described above.

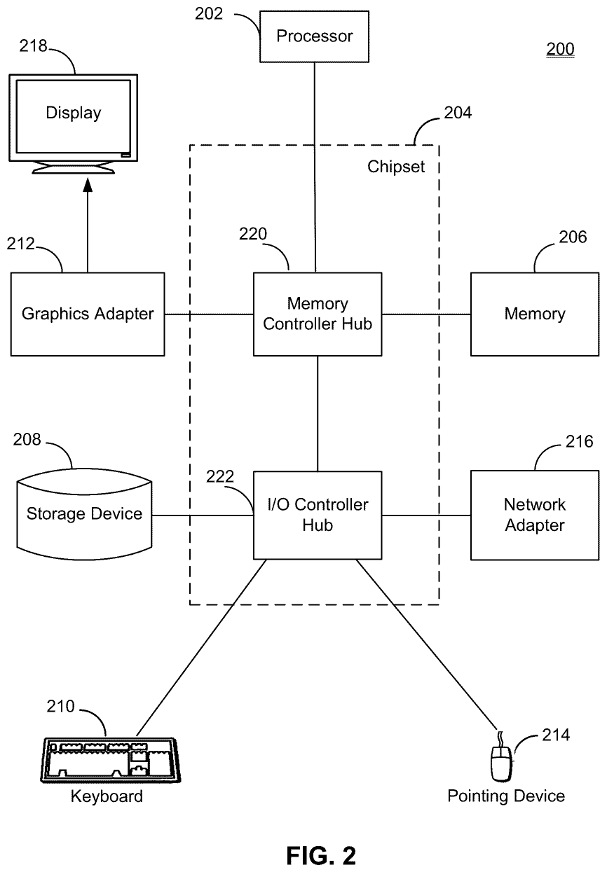

FIG. 2 is a block diagram illustrating one embodiment of a computer 200 suitable for use in the system 100 (e.g., as testing equipment 120 or the diagnostic system 130). Illustrated are at least one processor 202 coupled to a chipset 204. The chipset 204 includes a memory controller hub 220 and an input/output (I/O) controller hub 222. A memory 206 and a graphics adapter 212 are coupled to the memory controller hub 220, and a display device 218 is coupled to the graphics adapter 212. A storage device 208, keyboard 210, pointing device 214, and network adapter 216 are coupled to the I/O controller hub 222. Other embodiments of the computer 200 have different architectures. For example, the memory 206 is directly coupled to the processor 202 in some embodiments.

The storage device 208 includes one or more non-transitory computer-readable storage media such as a hard drive, compact disk read-only memory (CD-ROM), DVD, or a solid-state memory device. The memory 206 holds instructions and data used by the processor 202. The pointing device 214 is used in combination with the keyboard 210 to input data into the computer system 200. The graphics adapter 212 displays images and other information on the display device 218. In some embodiments, the display device 218 includes a touch screen capability for receiving user input and selections. The network adapter 216 couples the computer system 200 to the network 170. Some embodiments of the computer 200 have different or additional components than those shown in FIG. 2. For example, the diagnostic system 130 can be formed of multiple computers 200 operating together to provide the functions described. As another example, the testing equipment 120 can be a smartphone and include a touch-screen that provides on-screen keyboard 210 and pointing device 214 functionality.

The computer 200 is adapted to execute computer program modules for providing functionality described herein. As used herein, the term “module” refers to computer program instructions or other logic used to provide the specified functionality. Thus, a module can be implemented in hardware, firmware, or software, or a combination thereof. In one embodiment, program modules formed of executable computer program instructions are stored on the storage device 208, loaded into the memory 206, and executed by the processor 202.

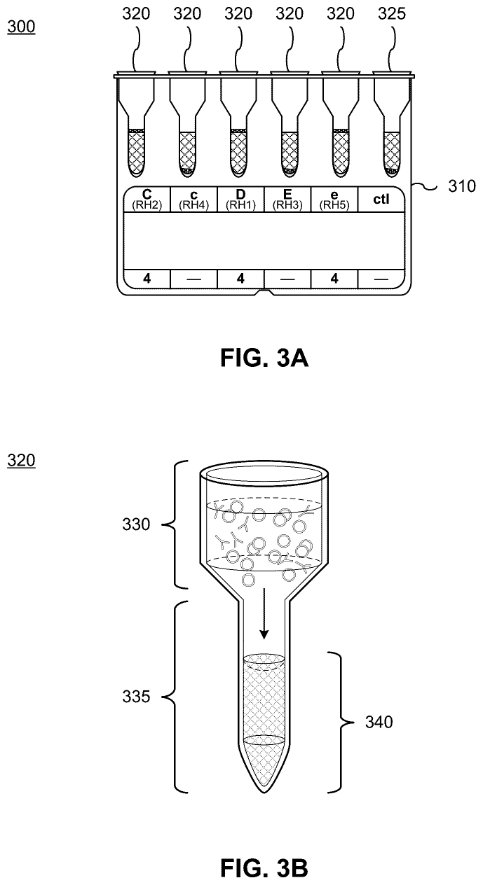

As described above, the test cards 110 used in conjunction with the testing equipment 120 and the diagnostic system 130 may be gel cards. FIG. 3A illustrates one embodiment of a gel card 300. The gel card 300 includes a plate 310 that holds one or more transparent (or partially transparent) containers or wells 320. Each well 320 may contain a gel containing a reticulation agent. The gel card 300 may additionally include a control well 325 that contains a gel without the reticulation agent. In some embodiments, the gel card 300 is used by introducing a drop of blood in each well, incubating the card, and centrifuging the card. FIG. 3A illustrates an example of a gel card 300 where red blood cells agglutinated and reminded on top of the first (RH2; c), third (RH1; D) and fifth (RH5; e) wells. Moreover, in the example of FIG. 3A, red blood cells did not agglutinate and fell to the bottom of the second (RH4; c), fourth (RH3; E) and sixth (control) wells.

FIG. 3B illustrates one embodiment of a well 320 of a gel card 300. The well 320 includes a top broad incubation chamber 330 for receiving a blood sample to be tested (and optionally a reagent). The well 320 additionally includes a bottom narrower well 335 having a tapered lower end. In some embodiments, the top broad incubation chamber 330 is coupled to the bottom narrower well 335 through a tapered lumen. The bottom narrower well 335 is filled with a separation matrix 340, such as a gel containing a reticulation agent. FIG. 3B additionally illustrates red blood cells from a blood sample reacting with a reagent in a fluid in the broad incubation chamber 330. After the blood sample is allowed to react with the reagent, the well is centrifuged to subject the blood sample to an force pushing the blood sample to the bottom narrower well 335. Based on whether the blood sample agglutinate, the force exerted to the blood sample may cause the blood sample to fall to the bottom of the well.

However, due to many factors, defects may be introduced into the separation matrix 340. For example, air bubble or large particles may be introduced to the separation matrix 340 (e.g., during a manufacturing process or simply while being stored after manufacturing has been completed). In some embodiments, the defects may not interfere with a biological reaction expected to take place within the well, but the defects may interfere with a diagnostic system's ability to read the gel card.

### Example Systems

FIG. 4 illustrates one embodiment of the testing equipment 120. As shown, the testing equipment 120 includes a camera 410, a network interface 420, a display 430, and a local data store 440. Other embodiments of the testing equipment 120 include different or additional components. For example, in embodiments where image processing and analysis is performed locally by the testing equipment 120, the network interface 420 might be omitted, and instead, some components of the diagnostic system 130 are included in the testing equipment 120.

The camera 410 captures images of test cards to be analyzed by the testing equipment 120. In some embodiments, the testing equipment 120 is a specialized equipment for processing test cards 110. The specialized equipment may include a holder configured to hold a test card 110 in a particular position and orientation to improve consistency in the image captured by the camera. In some embodiments, test cards are loaded into a loading tray and the testing equipment 120 includes a mechanism (such as a robotic arm) for placing the test cards in front of the camera 410. In other embodiments, the testing equipment is a mobile device, such as a smartphone, running a test card reading application. For example, the test car reading application may provide alignment guides to help the user of the mobile device align the test card 110 within the image captured by the camera 410. In some embodiments, the test card reading application provides instructions on how to take a picture of the test card. In other embodiments, the mobile device may be placed in holder that is also configured to hold a test card 110.

In some embodiments, the user accesses a test card reader application (e.g., a native application running on a specialized testing equipment, or a mobile application installed in a mobile device) which prompts the user to take a photograph that includes a test card 110. Alternatively, the user might take the photograph of the test card using a separate camera application and provides the photograph to be analyzed to the test card reader application (e.g., by loading the picture taken by the camera application in the test card reading application).

In one embodiment, where the testing equipment 120 includes a flash, the camera 410 automatically uses the flash if the overall brightness detected by the camera (or another sensor) is below a threshold. In another embodiment, the user may select whether the flash should be used (e.g., using controls provided on the display 430). Although the testing equipment 120 is shown as having only a single camera 410, one of skill in the art will recognize that the testing equipment 120 can have multiple cameras. For example, the testing equipment 120 may have cameras with different resolution or magnification. Moreover, the testing equipment 120 may have cameras facing different directions. When using such testing equipment 120, the user may be provided with controls (e.g., an on-screen button) to select between the available cameras.

The testing equipment 120 uses the camera 410 for capturing images of blank test cards to test the blank test cards prior to being used. Moreover, the testing equipment 120 uses the camera 410 for capturing images of test cards after the test cards have been used (e.g., after a sample has been introduced to the test card and a biological reaction has been allowed to take place). In some embodiments, the testing equipment 120 captures images of the test cards automatically. For example, the user operating the testing equipment 120 may load samples into a loading rack or holder and instructs the testing equipment 120 to process the loaded samples. The testing equipment 120 tests available blank test cards to determine if one or more of the available test cards are defective, selects a blank test card from the set of available blank test cards, executes a test protocol (such as introducing a sample into the selected blank test card, and allowing a biological reaction to take place in the test card), and automatically captures an image of the test card after the test protocol has been completed. In this embodiment, the testing equipment 120 may include a robotic arm to handle the test cards and execute the test protocol.

In some embodiment, the testing equipment 120 tests the available blank test cards immediately prior to being used. That is, after the user operating testing equipment 120 instructs the testing equipment 120 to process a sample, the testing equipment 120 selects a blank test card, tests the blank test card, and continues processing the sample with the selected blank test car if a determination is made that the blank test card is not defective (e.g., if a determination is made that defects in the blank test card is unlikely to interfere with the testing equipment's ability to properly process the test card). Alternatively, the testing equipment 120 tests available test cards once the blank test cards are loaded into the testing equipment, and discards or rejects defective blank test cards. Moreover, the testing equipment 120 may be able to receive multiple samples at once and may process the samples in batches automatically.

The network interface 420 couples the testing equipment 120 to the network 170. The network interface 420 transmits outgoing data (e.g., images captured by the camera 410) over the network 170 and receives incoming data (e.g., results read from an image of a test card). Received data is then routed to the appropriate component or components of the testing equipment 120 (e.g., a test card reader application). In various embodiments, the network interface 420 includes one or more of: a Wi-Fi network connection (e.g., using an 802.11 based protocol), a mobile data connection (e.g., using 3G, 4G, 4G-LTE, 5G, or the like), or a Bluetooth™ connection. In some embodiments where multiple network connections are available, the testing equipment 120 provides controls (e.g., on a display 430)) enabling the user to select which one to use. In other embodiments, the connection is selected automatically (e.g., based on the strength of the connections and/or the corresponding network speeds). One of skill in the art will recognize other types of network connection that may be used.

The display 430 presents information to the user, such as instructions on how to perform a test using a test card 110. For example, if the testing equipment 120 is an automated system for processing biological samples, the display 430 displays information asking a user to load one or more samples into the testing equipment 120. The display 430 may additionally give instructions on how to load the samples into the testing equipment 120. Additionally, the display 430 may provide user interface elements to allow the user to confirm samples have been loaded into the testing equipment, to select a type of test to be performed or a type of sample that was loaded, and to instruct the testing equipment 120 to start processing the samples. After the testing equipment 120 has finished processing the samples, the display 430 further presents information about the outcome of the test performed on the samples provided by the user.

In another embodiment, for a non-automated testing equipment, the display 430 presents instructions on how to obtain an appropriate image of a test card and the results obtained by analyzing an image of a test card. In one embodiment, the display 430 is a touchscreen. The test card reader app presents a user interface for obtaining images on the display 430. For example, the display 430 might present an instruction telling the user to take a photograph of a test card 110. The user then taps on a control to open a camera interface that displays a preview of what is currently being obtained by the camera 410. On selection of another control (or the same control a second time), an image is captured. In one embodiment, once an image is captured, it is presented to the user on the display 430 for review. The display 430 also includes a pair of controls, one to submit the image for analysis and the other to discard the image and capture another. If the user selects the submit control, the image is sent to the diagnostic system 130 for analysis (or sent to an analysis component of the testing equipment 120, in embodiments where the analysis is performed locally). In contrast, if the user selects the discard control, the camera preview is displayed again, and the user can capture a new image.

The local data store 440 includes one or more computer-readable storage media (e.g., hard drives, flash memory, etc.) that store software and data used as part of the test card reading process. In one embodiment, the local data store 440) stores the test card reader application, the images captured by the camera 410, and test results received from the diagnostic system 130. Images and test results can be encrypted and/or deleted a short time after use to protect against unauthorized access and copying. In other embodiments, some or all of this content is located elsewhere (e.g., at the diagnostic system 130 or a cloud storage facility) and accessed via the network 170.

FIG. 5 illustrates one embodiment of the diagnostic system 130. As shown, the diagnostic system 130 includes a result identification subsystem 540, a results store 560, a blank card testing subsystem 580, and a network interface 590. Other embodiments of the diagnostic system 130 include different or additional components. In addition, the functions may be distributed among the components in a different manner than described. For example, the results store 560 may be omitted, with results being stored either in a remote database or on the testing equipment 120 from which the image was received.

The result identification subsystem 540 identifies the result of the test or tests included in a test card 110. In some embodiments, the result identification subsystem 540) includes a reaction classification module, for classifying whether an image depicts a specific biological reaction corresponding to a test card. For example, if the test card is a gel card, the reaction classification module of the result identification subsystem 540 determines if images of the wells of the gel card show that specific biological reactions have taken place. In some embodiments, the reaction classification module uses one or more neural networks that determines one or more probabilities corresponding to an outcome of a biological reaction that took place in a test card. An example of a reaction classification module is described in International Application Publication No. WO/2020/192972, titled “Apparatus and Method for Classifying Pictures of Gel-Card Reactions,” which is incorporated by reference in its entirety.

Moreover, in some embodiments, identifying a result of a test card may include normalizing received images of test cards (e.g., cropping the images, rotating the images, and zooming the images) and identifying a type of the test card prior to applying the reaction classification module to the image of the test card. For instance, the diagnostic system 130 may be capable of processing multiple types of test cards. In this example, the diagnostic system 130 includes multiple reaction classification modules, each for analyzing a different type of test card. Thus, the result identification subsystem 540 identifies the type of the test card to select the appropriate reaction classification module for processing the image of the test card.

In some embodiments, the result identification subsystem 540 also produces a degree of certainty for the identified result. In one such embodiment, if the certainty is below a threshold, the result is discarded. Additionally or alternatively, results are returned to the testing equipment 120 along with the indication of certainty for presentation to the user. Thus, the user can make an informed decision regarding reliability of the result and decide whether another photograph should be taken.

The results store 560 includes one or more computer-readable storage media that store the results generated by the result identification subsystem 540 (e.g., the result of a diagnostic test, which is added to a patient's file). In one embodiment, the results store 560 is a hard drive within the diagnostic system 130. In other embodiments, the results store 560 is located elsewhere, such as at a cloud storage facility accessible via the network 170. One of skill in the art will recognize that various security precautions such as encryption and access control may be used to protect patient privacy and ensure compliance with local laws and regulations.

The blank card testing subsystem 580 analyzes blank test cards (i.e., test cards prior to being used for testing). The blank card testing subsystem 580 identifies the usability of a blank test card and determines whether defects in the blank test card is likely to interfere with the analysis of the test card after the test card has been used. The blank card testing subsystem 580 receives an image (e.g., captured by a camera 410 of a testing equipment 120) of a blank test card for identifying the usability of the blank test card. The blank card testing subsystem 580 modifies the received image to generate a synthetic image that mimics how the blank test card could look like after the test card has been used. In some embodiments, the blank card testing subsystem 580 additionally normalizes the images of blank test cards and determines a type of the blank test card prior to analyzing the blank test card.

In some embodiments, the blank card testing subsystem 580 generates synthetic images from the received image of the blank test card using a trained image-to-image translation model 582. The image-to-image translation model 582 may be trained based on a training set that includes images of test cards before and after the test card has been used. That is, the training set includes an image of a blank test card (source image) and an image of the blank test card after the test card has been used (target image). In some embodiments, the image-to-image translation model 582 is further trained based on a result of the test card (either as identified by the result identification module, or manually provided).

In some embodiments, the image-to-image translation model 582 is configured to translate images of blank test cards. Alternatively, in other embodiments, the image-to-image translation model 582 is configured to translate images of wells extracted from images of blank test cards. That is, the blank card testing subsystem 580 may extract images of each of the wells of a blank test card from an image of the blank test card and translates the images of each well independently. Example synthetic images generated by an image-to-image translation models 582 is illustrated in FIGS. 10 and 11.

In some embodiments, the blank card testing subsystem 580 may have multiple image-to-image translation models 582 for translating wells. For example, the blank card testing subsystem 580 may have a first image-to-image translation model 582 for translating a source image to a synthetic image mimicking biological reaction having a positive test result, a second image-to-image translation model 582 for translating a source image to a synthetic image mimicking biological reaction having a negative test result. An example synthetic image generated by a system using multiple image-to-image translation models 582 is illustrated in FIG. 10.

The image-to-image translation model 582 may be trained using a generative adversarial network (GAN) or a conditional adversarial network (cGAN). The GAN architecture may have a generator model for generating a synthetic image from a source image, and a discriminator for determining whether an image is a real image or a synthetic image. The generator model receives an image of a blank test card and generates a synthetic image from the received image of the blank test card. The discriminator receives a source image (corresponding to a blank test card) and a target image (corresponding to the blank card after it has been used), and determines whether the target image is a real image or a synthetic image generated by the generator model. In some embodiments, the discriminator determines whether a target image is a real image or a synthetic image without being provided with the source image corresponding to the target image.

The generator model and the discriminator model are trained using an adversarial process. For example, after the generator model generates a synthetic image based on a source image in the training set, the source image and the synthetic image are provided to the discriminator model. The discriminator model then evaluates whether the image generated by the generator model is a real target image or a synthetic image. The output of the discriminator model is then provided to the generator model as feedback to further refine the generator model. That is, the generator model is provided with information regarding whether the discriminator model correctly identified the image generated by the generator model as a synthetic image or incorrectly identified the image generated by the generator model as a real image. The generator model is then allowed to adjust based on whether the discriminator model correctly identified the image generated by the generator model as a synthetic image.

Similarly, once the discriminator model has evaluated a target image, the ground truth regarding the target image is provided to the discriminator to further refine the discriminator. That is, information whether the target image provided to the discriminator model is a real image or a synthetic image generated by the generator model is provided to the discriminator model to further refine the discriminator model. The discriminator model is then allowed to adjust based on whether the discriminator model correctly evaluated the target image as a real image or a synthetic image.

In some embodiments, the diagnostic system 130 refines the image-to-image translation model 582 based on new images of blank test cards and used test cards provided by users through testing equipment 120. That is, as users consume test cards, the diagnostic system 130 collects images of blank test cards provided by users for identifying the usability of the blank test card prior to using the test card, and images of used test cards provided by users for reading the test results indicated by the test card. In some embodiments, a first subset of images provided to the diagnostic system 130 in the course of its normal operation (i.e., as users provide images of test cards the users are consuming) are stored to be used as training data to train the image-to-image translation model 582, and a second subset of images provided to the diagnostic system 130 in the course of its normal operation are stored to be used as a validation or testing data set to determine the effectiveness or accuracy of the image-to-image translation model 582.

The blank card testing subsystem 580 then uses the result identification subsystem 540 for analyzing the synthetic images and compares the output of the result identification subsystem 540 to an expected result. In some embodiments, the expected result is determined based on how the received image of the blank test card was modified. That is, the received image is modified to mimic how the blank test card would look like if it contains the expected result. For example, if an image-to-image translation model 582 generates synthetic image from a source image to mimic how the source image would look like if it contains a negative test result, the blank card testing subsystem 580 determines whether the output of the result identification subsystem 540 indicates a negative test result. Alternatively, if an image-to-image translation model 582 generates synthetic image from a source image to mimic how the source image would look like if it contains a positive test result, the blank card testing subsystem 580 determines whether the output of the result identification subsystem 540 indicates a positive test result.

In some embodiments, the blank card testing subsystem 580) determines whether the output of the result identification subsystem 540 is a valid result or an invalid result. In some embodiments, valid results include true positives or true negatives. Additionally, invalid results include false negative, false positives. Moreover, invalid results may include errors indicating that the result identification subsystem 540 was unable to determine a test result for the synthetic images.

By generating synthetic images and using the result identification subsystem 540 to classify the synthetic images, a new classification model does not need to be trained to determine whether defects in a blank test card would interfere with an analysis conducted by the result identification subsystem 540 on the test card after being used. That is, since the synthetic image mimics how the test card could look like after being used, if the result identification subsystem 540 is unable to make a correct classification of the synthetic image, the blank card testing subsystem 580 can infer that the defects in the blank test card are likely to interfere with a real test performed using the defective blank test card.

In some embodiments, the blank card testing subsystem 580 applies a binary classifier 584 to classify the received image of the blank test card based on the outcome of the results identification subsystem 540 for the one or more synthetic images. In some embodiments, the binary classifier 584 classifies the image of the blank test card as pass or fail

In some embodiments, the binary classifier 584 classifies the image of the blank test card based on the outcome of the result identification subsystem 540 for a single synthetic image. For example, the binary classifier 584 determines whether the outcome of the result identification subsystem 540 matches an expected outcome. Alternatively, the binary classifier 584 classifies the image of the blank test card based on the outcome of the result identification subsystem 540 for multiple synthetic images. For instance, the binary classifier 584 classifies the image of the blank test card based on the outcome of the result identification subsystem 540 for a first synthetic image generated by a first image-to-image translation model mimicking a positive biological reaction, and a second synthetic image generated by a second image-to-image translation model mimicking a negative biological reaction. In this example, the binary classifier 584 determines whether the outcome of the result identification subsystem 540 for each of the synthetic images match a corresponding expected outcome. Moreover, for test cards with multiple tests, the binary classifier 584 may classify the image of the blank test card based on one or more synthetic images for each test in the blank test car. If the outcome of the result identification subsystem 540 for every synthetic image matches the corresponding expected outcome, the binary classifier 584 classifies the image of the blank test card as pass. Alternatively, if at least one output for a synthetic image does not match the corresponding expected outcome, the binary classifier 584 classifies the image of the blank test card as fail.

The network interface 590 couples the diagnostic system 130 to the network 170. The network interface 590 transmits outgoing data (e.g., results read from an image of a test card) over the network 170 and receives incoming data (e.g., images captured by the camera 410). Received data is then routed to the appropriate component or components of the diagnostic system 130 (e.g., the result identification subsystem 540 or the blank card testing subsystem 580).

### Example Methods

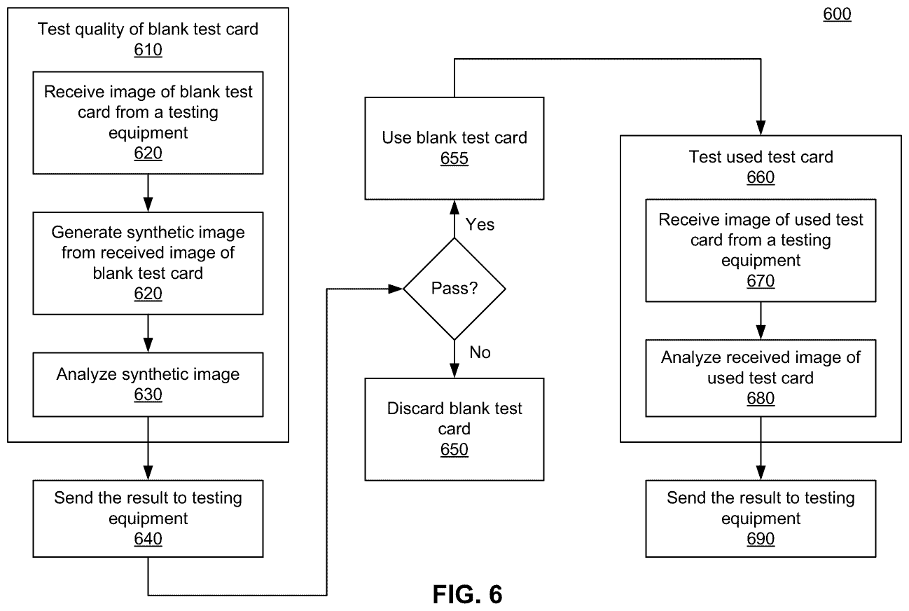

FIG. 6 illustrates one embodiment of a method 600 for using a test card using the camera 410 of a testing equipment 120. Although some of the steps are described as being performed by the diagnostic system 130, it can be understood that one or more of those steps may be performed by other entities, such as the test equipment 120. In addition, some embodiments may perform the steps in parallel, perform the steps in different orders, or perform different steps.

In the embodiment shown in FIG. 6, the method 600 begins with testing 610 the quality of a blank test card. To test the blank test card, the diagnostic system 130 receives 620 an image of the blank test card. The image of the blank test card may be received from the testing equipment 120. For instance, a user preparing to use a test card captures an image of the test card before being used (blank test card) and provides the image of the blank test card to the diagnostic system 130.

The blank card testing subsystem 580 of the diagnostic system 130 generates one or more synthetic images from the received image of the blank test card. The synthetic images are generated using one or more image-to-image translation model 582 trained to mimic how the blank test card may look like after the blank test card has been used to run a specific test. In some embodiments, the test card includes multiple individual tests. For example, a gel card includes multiple wells, each containing a gel for enabling a biological reaction to take place once a biological sample is introduced to the well. The blank card testing subsystem 580 may identify the individual tests in the blank test card and generates a synthetic image for each test in the blank test card. For instance, for blank gel card having multiple wells, the blank card testing subsystem 580 generates a synthetic image for each well. Alternatively, the blank identification subsystem 580 generates a synthetic image containing multiple tests.

In some embodiment, the blank card testing subsystem 580 applies multiple image-to-image translation modules 582 to generate multiple synthetic images for a blank test card. In some embodiments, each image-to-image translation model 582 mimics different biological reactions. For example, the blank card testing subsystem 580 uses a first image-to-image translation module 582 mimicking a positive test result to generate a first synthetic image, and a second image-to-image translation model 582 mimicking a negative test result to generate a second synthetic image.

The result identification subsystem 540 analyzes 630 the synthetic images and determines a test result. The result identification subsystem 540 analyzes the synthetic images is if the synthetic images were real images of a test card taken after the test card has been used. For instance, the result identification subsystem 540 analyzes the synthetic images to determine a likelihood that a biological reaction has taken place.

The blank card testing subsystem 580 applies binary classifier 584 to classify the source image based on the outcome of the results identification subsystem 540 for the one or more synthetic images. In some embodiments the blank card testing subsystem 580) compares the outcome of the result identification subsystem 540 to an expected result to determine whether the blank test card is usable. That is, the blank card testing subsystem 580 uses the analysis of the one or more synthetic images generated from a source image to classify the source image. The blank card testing subsystem 580 applies binary classifier 584 to classify the source image based on the outcome of the results identification subsystem 540 for the one or more synthetic images.

The outcome of the binary classifier 584 is sent 640 to the testing equipment 120 to present the classification of the image of the blank test card to a user of the testing equipment (e.g., through display 430). In some embodiments, the testing equipment 120 provides instructions to the user based on the outcome of the binary classifier 584. For example, if the binary classifier 584 classifies the image of a blank test card as fail, the testing equipment 120 instructs the user to discard the blank test card and start over with a new blank test card. Based on the information displayed by the testing equipment 120, the user may either discard 650 the blank test card (e.g., if the binary classifier 584 classified the image of the blank test card as fail), or may proceed to use 655 the blank test card (e.g., if the binary classifier 584 classified the image of the blank test card as pass).

Once the test card has been used and a biological reaction has been allowed to take place in the test card, the used test card is tested 660. To test the used test card, the diagnostic system 130 receives 670 an image of the used test card. The image of the used test card may be received from the testing equipment 120. Once the image of the used test card is received, the diagnostic system 130 analyzes the image of the used test card 680 and provides test results for the test card based on the analysis.

The diagnostic system 130 sends 690 the result to the testing equipment 120. In one embodiment, the testing equipment 120 presents the result to the user on its display 430. In other embodiments, the diagnostic system 130 also sends the calculated confidence level to the testing equipment 120. In one such embodiment, the testing equipment displays the result and the corresponding confidence level on the display 430. Thus, if the user decides the confidence level is inadequate, the user can capture a new image and provide it for analysis in an attempt to achieve greater certainty. One of skill in the art will recognize various ways in which the result can be processed and displayed at the testing equipment 120.

### Examples

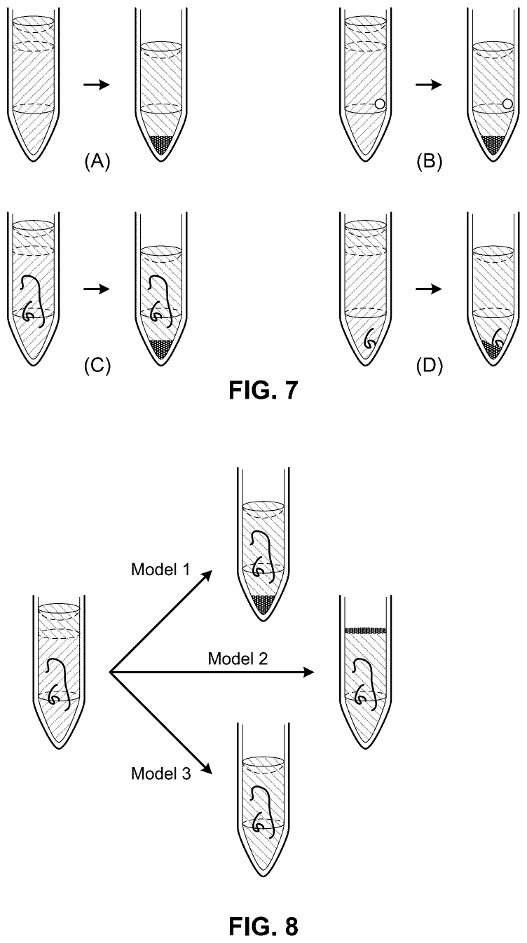

FIG. 7 illustrates multiple examples of an image-to-image translation of wells in a gel card, according to one embodiment. FIG. 7 shows four source images of a well of a blank gel card, and corresponding synthetic images generated using an image-to-image translation model. The First example (A) shows a well of a blank gel card without visible defects. The second example (B) shows a well of a blank gel card having an air bubble. The third example (C) shows a well of a blank gel card having large particles. The fourth example (D) shows a well of a blank gel card having a particle near the bottom of the well.

FIG. 8 illustrates an example of a system using multiple image-to-image translation models, according to one embodiment. In particular, the example of FIG. 8 shows a source image of a well of a gel card having defects, a first synthetic image generated using a first image-to-image translation model (e.g., mimicking a negative biological reaction), a second synthetic image generated using a second image-to-image translation model (e.g., mimicking a positive biological reaction), and a third synthetic image generated using a third image-to-image translation model (e.g., mimicking no biological reaction taken place).

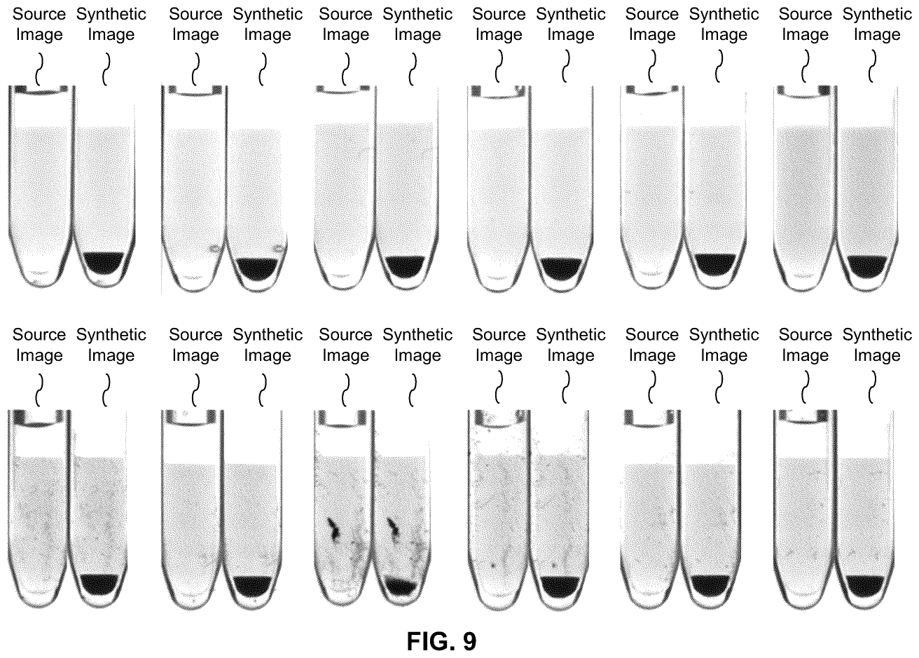

FIG. 9 illustrates multiple examples of source images and synthetic images generated using an image-to-image translation model, according to one embodiment. In particular, FIG. 9 shows twelve examples of source images having various types of defects, and corresponding synthetic images generated using an image-to-image translation model. Each of the synthetic images can then be classified (e.g., using a reaction classification model to analyze the synthetic images and a binary classified using the output of the reaction classification model).

### Additional Considerations

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as subsystems, without loss of generality.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and process for reading test cards using a testing equipment. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein. The scope of the invention is to be limited only by the following claims.

What is claimed is:

1. A method for classifying a blank test card, comprising:
receiving a source image of the blank test card;
generating one or more synthetic images by applying an image-to-image translation model to the source image; and
applying a classifier to the one or more synthetic images to determine a classification of the blank test card.

2. The method of claim 1, applying the classifier to the one or more synthetic images to determine a classification of the blank test card comprises:
determining one or more test results for the one or more synthetic images by applying a trained model to the one or more synthetic images; and determining a classification for the received source image of the blank test card by applying a binary classifier based on the determined one or more test results for the one or more synthetic images.

3. The method of claim 2, wherein applying the binary classifier comprises:
determining whether each test result is an invalid test result; and
responsive to determining that at least one test result is an invalid test result, assigning a fail classification to the received source image.

4. The method of claim 2, wherein applying the binary classifier comprises:
determining whether each test result is a valid test result; and
responsive to determining that every test result is a valid test result, assigning a pass classification to the received source image.

5. The method of claim 2, wherein applying the binary classifier comprises:
comparing each determined test result to a corresponding expected test result; and
responsive to at least one determined test result not matching the corresponding expected test result, assigning a first classification to the received source image, and
responsive to every determined test result matching the corresponding expected test result, assigning a second classification to the received source image, different than the first classification.

6. The method of claim 1, wherein the image-to-image translation model is trained using a generative adversarial network.

7. The method of claim 1, wherein the image-to-image translation model is trained using a training set including source images of a plurality of test cards before being used and target images of the plurality of test cards after being used.

8. The method of claim 1, wherein the trained model for determining the one or more test results is a reaction classification model for classifying a biological reaction depicted in an image.

9. The method of claim 1, wherein the blank test card is a blank gel card including a plurality of wells, and wherein each well of the plurality of wells contains a gel and a reticulation agent.

10. A computing device for testing a blank test card, comprising:
an image-to-image translation model configured to receive a source image of the blank test card and generate one or more synthetic images from the received source image of the blank test card;
a classifier module configured to receive the one or more synthetic images and determine a classification of the blank test card based on the one or more synthetic images.

11. The computing device of claim 10, wherein the classification module comprises:
a test result identification subsystem configured to determine one or more test results for the one or more synthetic images by applying a trained model to the one or more synthetic images; and
a binary classifier configured to receive the one or more test results and determine a classification for the received source image of the blank test card based on the determined one or more test results for the one or more synthetic images.

12. The method of claim 11, wherein applying the binary classifier comprises:
determining whether each test result is an invalid test result; and
responsive to determining that at least one test result is an invalid test result, assigning a fail classification to the received source image.

13. The method of claim 11, wherein applying the binary classifier comprises:
determining whether each test result is a valid test result; and
responsive to determining that every test result is a valid test result, assigning a pass classification to the received source image.

14. The computing device of claim 11, wherein the binary classifier is configured to:
compare each determined test result to a corresponding expected test result;
responsive to at least one determined test result not matching the corresponding expected test result, assign a first classification to the received source image, and
responsive to every determined test result matching the corresponding expected test result, assign a second classification to the received source image, different than the first classification.

15. The computing device of claim 10, wherein the image-to-image translation model is trained using a generative adversarial network.

16. The computing device of claim 10, wherein the image-to-image translation model is trained using a training set including source images of a plurality of test cards before being used and target images of the plurality of test cards after being used.

17. The computing device of claim 10, wherein the trained model for determining the one or more test results is a reaction classification model for classifying a biological reaction depicted in an image.

18. The computing device of claim 10, wherein the blank test card is a blank gel card including a plurality of wells, and wherein each well of the plurality of wells contains a gel and a reticulation agent.

19. A system comprising:
a testing equipment having a camera and a display, the camera configured to obtain a source image including a blank test card; and
a diagnostic system, communicably coupled to the testing equipment, and configured to:
receive a source image of the blank test card from the testing equipment;
generate one or more synthetic images by applying an image-to-image translation model to the source image;
apply a classifier to the one or more synthetic images to determine a classification of the blank test card; and
send the classification of the blank test card to the testing equipment.

20. The system of claim 19, wherein applying a classifier to the one or more synthetic 20. images to determine a classification of the blank test card comprises:
determining one or more test results for the one or more synthetic images by applying a trained model to the one or more synthetic images; and
determining a classification for the received source image of the blank test card by applying a binary classifier based on the determined one or more test results for the one or more synthetic images.
